(19) United States
(12) Patent Application Publication
(10) Pub. No.: US 2009/0171646 A1
(43) Pub. Date: Jul. 2, 2009

(54) METHOD FOR ESTIMATING POWER CONSUMPTION

(75) Inventors: Michael Silbermintz, Tel Mond (IL); Dimitri Akselrod, Burlington (CA); Boris Bobrov, Ceasarea (IL); Michael Priel, Hertzelia (IL); Amihay Rabenu, Hadera (IL); Amir Sahar, Kfar Saba (IL); Shiri Shem-Tov, Ramat-Gan (IL); Boris Shulman, Kfar Saba (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor , Inc., Austin, TX (US)

(21) Appl. No.: 11/574,495

(22) PCT Filed: Aug. 31, 2004
(86) PCT No.: PCT/EP2004/011077

§ 371 Date: Nov. 20, 2008

(51) Int. Cl. G06G 7/62

(52) U.S. Cl. 703/16; 703/21

(57) ABSTRACT

A method for determining system and software configuration that includes: calculating a power consumption estimate of a modeled system associated with an execution of a certain software code; and altering, in response to the power consumption estimate, the certain software code or the modeled system. A method of determining a power consumption of a system that executed a software code, the method includes the stages of: providing a reduced instruction set representation of the software code; and calculating a power consumption estimate of a modeled system associated with an execution of the reduced instruction set representation of the software code.

### FIELD OF THE INVENTION

The present invention relates to methods for estimating power consumption of an integrated circuit and especially of estimating power consumption of a system that executes a certain software code.

### BACKGROUND OF THE INVENTION

Mobile devices, such as but not limited to personal data appliances, cellular phones, radios, pagers, lap top computers, and the like are required to operate for relatively long periods before being recharged. These mobile devices usually include one or more processors as well as multiple memory modules and other peripheral devices.

On one hand, mobile devices include growing amounts of components and are required to execute multiple tasks of increasing complexity. On the other hand, the battery technology is characterized by a relatively slow development rate.

Due to various reasons, including the mentioned above reasons, modern integrated circuits, and especially those that are designed for the mobile device market must illustrate a reduced power consumption level. It is noted that the power consumption of integrated circuits aimed for stationary devices is also important due to various side effects (such as heat) of large power consumption.

Due to the vast amount of development required for developing modern integrated circuits and the demand to shorten the design stage of integrated circuits it is desirable to estimate the power consumption of an integrated circuit at early stages of the design.

Various prior art methods are aimed for designing integrated circuited while taking into account some power consumption considerations. These methods are implemented in various stages of the design process. U.S. Pat. No. 6,513,145 of Venkitakrishnan titled “method for estimating the power consumed in a microprocessor”; U.S. patent application 20030110020 of Blatt et al., titled “power modeling methodology for a pipelined processor”; U.S. Pat. No. 6,345,379 of Khouja et al., titled “method and apparatus for estimating internal power consumption of an electronic circuit represented as netlist”; all of which are incorporated herein by reference, provide a brief illustration of some of the prior art methods.

Some prior art methods include simulating an execution of a benchmark program by a processor and estimating the maximal power consumption of the processor. Other methods estimate the power consumption based upon information available at the gate library level of the modeled hardware.

Various post-design methods for reducing the power consumption of a integrated circuits are known in the art. A first technique includes reducing the clock frequency of the integrated circuit. A second technique is known as dynamic voltage scaling (DVS) or alternatively is known as dynamic voltage and frequency scaling (DVFS) and includes altering the voltage that is supplied to an integrated circuit as well as altering the frequency of a clock signal that is provided to the integrated circuit in response to the load demands (also referred to as throughput) of the integrated circuit. Higher voltage levels are associated with higher operating frequencies and higher computational load but are also associated with higher energy consumption.

There is a need to provide an effective method for estimating power consumption of a system that includes a processor, especially during the initial design stages of the system, such as during a system architecture definition stage.

### SUMMARY OF THE PRESENT INVENTION

The invention provides a method for determining a configuration of a system that includes modeled hardware components as well as determining the configuration of software to be executed by the system configuration. The method includes a stage of calculating an estimate of power consumed during the execution of a certain software code by the system. This calculation can be followed by a stage of altering, in response to the power consumption estimate, the certain software code, the system or both.

The invention provides a method for determining a power consumption of a system that executes a software code, the method includes a stage of providing a reduced instruction set representation of the software code; and calculating a power consumption estimate of a system associated with an execution of the reduced instruction set representation of the software code.

### BRIEF DESCRIPTION OF THE DRAWINGS

The present invention will be understood and appreciated more fully from the following detailed description taken in conjunction with the drawings in which:

FIG. 1 is a schematic illustration of a model of a system that includes multiple modeled hardware components, according to an embodiment of the invention;

FIG. 2 is a flow chart of a method for determining a power consumption of a system that executes a software code, according to an embodiment of the invention;

FIG. 3 is a flow chart of a method for determining a power consumption of a system that executes a software code, according to an embodiment of the invention; and

FIG. 4 is a flow chart of a method of for determining system and software configuration, according to an embodiment of the invention.

### DETAILED DESCRIPTION OF PREFERRED EMBODIMENTS

The power consumption estimate of a system that executes a reduced instruction set representation of a certain software code is responsive to various parameters including the modeled hardware components that participate in the execution, the operating mode of each of the modeled hardware components during the execution, the power consumption of each modeled hardware component at each operating mode, and the timing associated with the execution of instructions. It is noted that even modeled hardware components that do not participate in the execution can contribute to the power consumption, for example via leakage or idle power consumption.

The reduced instruction set usually includes a small amount of instructions that simplifies the calculation of the power consumption of the system.

The system includes multiple modeled hardware components and usually some (if not all) of the modeled hardware components can operate in various operation modes that differ from each other by their power consumption. Different operating modes are usually characterized by different supply voltage provided to the modeled hardware components. The voltage supply is associated with a clock signal frequency. Lower voltage supply levels result in lower clock signal frequencies. Conveniently, voltage provided to the modeled system and other variables of the modeled system can be changed on-the-fly during the execution of a simulated program.

According to various embodiments of the invention the operating mode of a certain modeled hardware component at a certain moment can be determined by at least one of the following manners: (i) setting the operating mode of the certain modeled hardware component, (ii) setting the operating mode of a group of modeled hardware component that includes the certain modeled hardware component, (iii) allowing the modeled hardware component to adjust its operating mode in view of the load on the modeled hardware component, (iv) allowing one or more modeled hardware components that belong to a certain group of modeled hardware components to adjust the operating mode of the group in view of the load on one of the modeled hardware components of the group.

It is noted that such a group of modeled hardware components is also referred to as frequency region. Various examples of operating mode settings are provided later on. The various operating mode setting facilitates modeling DVFS techniques, thus increase the accuracy of the power consumption estimate.

Modeled hardware components that form a group of modeled hardware components are allowed to report to one of the modeled hardware components or to a virtual power management entity what is their current operating mode. These reports can trigger an adjustment of the operating mode of the whole group. The reports can be provided immediately after the modeled hardware module alters its operating mode, after a predefined time period lapses from said alteration, in a periodical manner or in a combination of any of these report manners.

Various modeled hardware components are capable of altering their operating mode automatically. For example, a memory module can enter an active state when a data is read from him or when data is written to it and enter an idle state of operation after said activity ends. A modeled processor can enter an idle mode while waiting a certain data access operation to be completed, and exit said mode when a certain amount of requested data arrives.

Typically, during the design stage of integrated circuits (systems), multiple software codes are evaluated in view of the power to be consumed during their execution. The results can be used to modify the software code and/or the configuration of the integrated circuit.

These software codes can be programmed in response to the expected use of the integrated circuit. For example, an integrated circuit such as a system-on-chip that is designed for mobile phones, is programmed to execute video processing software code, audio processing software code, data processing code, multi-tasking and operating system software code. Some of the software code can be taken from pervious generations of the system-on-chip, while other are newly developed. Conveniently, while there is no need to reproduce the exact functionality of the software code, but rather a high-level representation is sufficient, there is a need to provide a good enough estimation of the system's performance and power consumption.

By determining the power consumed by executing software codes that will eventually be executed by the designed integrated circuit, the method enables to tailor the integrated circuit and the software to comply with power consumption demands of a substantially realistic environment.

Conveniently, the method can be used for estimating the power consumption associated with various user-provided software code, and is not bound to a small amount of benchmark software.

The method can be used for estimating small software segment codes, and determining the power consumption of multiple modeled hardware components in addition to the modeled processor.

The inventors modeled various modeled hardware components such as a bus, a bus arbiter, a bus bridge, a cache memory, a communication controller, a processor, a direct memory access controller, a First In First Out (FIFO) unit, a memory module, a peripheral, a SDRAM module and a task scheduler. It is noted that other modeled hardware components can be modeled and that a modeled system does not necessarily include all of these modeled hardware components.

The model is a high level model and is written in C++ language. The system components were modeled by C++ language and were linked with a library named SystemC which enabled the inventors to express concurrency, reactive behavior and timing. It is noted that various well-known software development tools, languages and the like can be utilized for providing such a model.

Each of said models allows to determine the amount of time required to execute a certain instruction, and the operating mode required for such execution thus allowing to estimate the power consumption of the system.

A typical model is characterized by an operating mode, power related parameters, configuration parameters (such as internal memory size), timing parameters (such as latency, decision period), and additional policy parameters (for example arbitration parameters, priority, pipeline related parameters and the like). Usually, each modeled hardware component can operate in an operating modes such as idle, stop, and active. It is noted that some modeled hardware components can operate in additional operation modes and that operation modes can be added or deleted by the user. For example, typical additional operation modes include peak, average, well-bias, leakage and the like.

These mentioned above parameters affect the manner in which each modeled hardware component executes a given instruction and thus defines the power consumption of the modeled hardware component.

The power consumption of most modeled hardware components is responsive to the voltage supply they receive and to the modeled hardware component operating frequency, but this is not necessarily so. For example, the power consumption of the bus module is responsive to the voltage supplied to the bus, the bus capacitance and a bus power consumption coefficient that can be provided by a user. Furthermore, the power consumption of some modeled hardware components, such as a CMOS camera, does not depend upon their operating frequency. It is noted that various models for power consumption can be applied and can be dynamically altered.

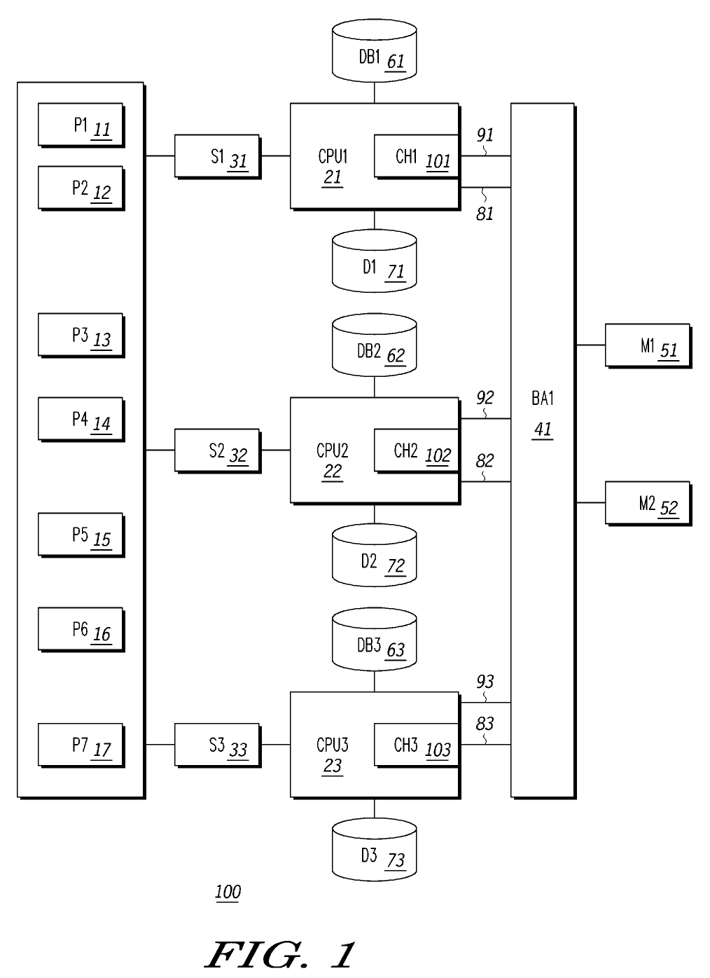

FIG. 1 is a schematic illustration of a model 100 of a system that includes multiple modeled hardware components, according to an embodiment of the invention. Model 100 includes multiple modeled peripherals P1-P7 11-17, three modeled processors CPU1-CPU3 22-23, three modeled task schedulers S1-S3 31-33, modeled bus arbiter BA1 41, multiple modeled high level memory modules M1-M2 51-51, three modeled databases DB1-DB3 61-63 that store portions of reduced instruction set representation of a certain software code (also referred to as “software code representation”), and three modeled statistics databases D1-D3 71-73 for gathering information representative of the execution of the software code representation. Each of modeled processors CPU1-CPU3 31-33 includes a modeled internal cache module CH1-CH3 101-103.

First modeled processor CPU1 21 is connected to first modeled task scheduler S1, to first modeled database DB1 61, to modeled peripherals P1-P7 11-17, to first modeled statistics database D1 71 and, via first modeled instruction bus I1 81 and first modeled data bus 91 to the modeled bus arbiter 41. It is noted that each of said modeled busses is associated with a modeled address bus (not shown). Second modeled processor CPU2 22 is connected to second modeled task scheduler S2, to second modeled database DB2 62, to modeled peripherals P1-P7 11-17, to second modeled statistics database D2 71 and, via second modeled instruction bus 82 and second modeled data bus 92 to the modeled bus arbiter 42. Third modeled processor CPU3 23 is connected to a third modeled task scheduler S3, to third modeled database DB3 63, to peripherals P1-P7 11-17, to third modeled statistics database D3 71 and, via third modeled instruction bus 83 and third modeled data bus 93 to modeled bus arbiter 41. The modeled bus arbiter 41 is connected to the modeled high-level memory modules M1-M2 51-51.

The content of the modeled statistics databases D1-D3 71-73 can be processed to provide various information about the operation of the modeled system. It may include providing a list of modeled hardware components, and the time periods during which each modeled hardware component operated at a certain operation mode. These statistic databases can be processed to provide average power consumption, peak power consumption, average voltage, average current, peak current, peak voltage and the like.

Each modeled scheduler out of S1-S3 31-33 is capable of receiving interrupt requests from each of the modeled peripherals P1-P7 11-17, and to determine which interrupt request to send to the corresponding modeled processor. Each modeled processor executes a portion of the reduced instruction set representation of the software code that is stored within the corresponding database connected to that modeled processor. In addition, each modeled processor can also service an interrupt request that is initiated by a peripheral module.

The method can produce various power consumption reports. A first report can list the modeled hardware components and the time (or relative time) each modeled hardware component was operating in each operation mode. A second report can provide statistical information about simulated current and voltage consumed during each operational mode or per the whole simulation period.

Conveniently, each reduced instruction set representation of the software code portion includes read, write and execute commands. Read and write commands can involve fetching data from a high level memory, or cache module and if a cache miss occurs the data is retrieved from the high level memory module. The modeled processor that caused the cache miss can enter a low energy consumption mode until the data if fetched. The fetching process timing depends upon the path the fetched data has to pass and various timing and arbitration parameters that are associated with bus arbiter 41, and the memory module.

The inventor used a reduced instruction set that includes the following instructions: EX, RD, WR, RQ, and NOTIFY.

The execute command (EX) represents an execution of at least one instruction by the modeled processor and may be associated with an execution cycle parameter and an operating mode parameter. The execution cycle parameter represents the time required for executing the at least one instruction and the modeled processor will wait for the required period (while entering a certain operating mode) before executing the next command. The execute command may be associated with a file name that is a source of one or more commands.

The read command (RD) can be associated with the amount of data to be read, and either the name of the modeled hardware component that stores the requested data or an address of the data.

The write command (WR) can be associated with the amount of data to be written, and either the name of the modeled hardware component that shall receive the requested data or an address of components that shall store the data.

The RQ command is related to the scheduling of interrupts and is associated with zero latency and the NOTIFY command involves sending a certain value to a certain target modeled hardware component. For example, the NOTIFY command can be used to set the operation mode of a certain modeled hardware component of a certain frequency domain.

The execution of RD, WR and EX takes at least one clock cycle. Each command is associated with an optimal execution time which ignored system latencies and is an input parameter of the model, and there is the actual execution time which also depends upon system constraints.

The optimal time of RD or WR command is the time required to transfer a certain amount of data over a bus. The actual time takes into account arbitration latencies, memory access latencies ad the like.

The EX command includes instruction fetch operations, data load/store operations and processor internal execution time.

Conveniently, a trace file reflecting the operation of each modeled processor is generated and stored within the statistics database associated with the modeled processor.

The power consumption of a certain modeled hardware components can also be provided in relation to predefined situations such as during power startup, frequency domain activation, wait mode and the like.

According to an embodiment of the invention the reduced instruction set representation of the software code is generated in response to a trace representation of the software code. The trace representation usually includes one or more trace files. Conveniently, a processor simulator is fed with the software code and in turn provides one or more trace file representing the execution of the software code by the processor. An exemplary trace file is illustrated by TABLE 1. This is a trace file of a simulated processor that can initiate up to one instruction fetch operation and two data fetch operations, per cycle.

TABLE 1

| | | | | | Size |
|---|---|---|---|---|---|
| Cycle | First | First | Second | Second | of |
| # | Instruction | address | Instruction | address | data |
| 50 | P | 1c20 | | | |
| 51 | P | 1c30 | | | |
| 52 | P | 1c40 | | | |
| 54 | P | 1c50 | | | |
| 56 | PX | 79c0 | R | 18728 | 32 |
| 57 | P | 79d0 | | | |
| 58 | P | 79e0 | | | |
| 59 | W | 40000 | W | 40004 | 32 |
| 60 | P | 79f0 | | | |
| 62 | P | 7a00 | | | |
| 64 | W | 1872c | | | |

Each row of the table represents a certain clock cycle. P is an instruction fetch instruction, PX is a instruction and data fetch instruction, W is a write instruction, R is a read instruction, the first address is associated with the first instruction while the second address (if exists) is associated with the second instruction. The instruction can also include a no access instruction. Another instruction that can be found within a typical trace file is the cache flush and cache invalidate instructions. Conveniently, such commands are associated with a certain cache memory space, which effects the duration of these command execution. The trace file can be associated with a predefined pipeline depth.

The power estimate of various modeled hardware components can be measured or calculated. The inventors used a hybrid estimate that was responsive to simulated voltage and current values as well as characteristic voltage and current values of real integrated circuits. It is noted that other power estimates can be utilized, including estimated that are responsive only to characteristic value or estimates that are only responsive to simulated values. The following equations were used by the inventors:

PPC(m)=Iinit(m)*V²/(Vinit(m)*Finit(m)). (1)

PPT_bus=BusCoeff*C*V². (2)

PPC_{—}F_{—}ind(m)=Iinit(m)*V²/(Vinit(m)*F). (3)

PPC_Leak=LeakCoef*Iinit(S)*V/F. (4)

Whereas index m represents a (hardware) operation mode, Iinit(m) is characteristic current at a certain operation mode, Iinit(S) is a is characteristic current at a “stop” operation mode, Vinit(m) is characteristic voltage at a certain operation mode, Finit(m) is characteristic frequency at a certain operation mode, V is the simulated voltage, F is the simulated frequency, BusCoeff is the bus power consumption coefficient, C is the bus capacitance, PPC(m) is a power consumption of a typical modeled hardware component per clock cycle, PPT_bus(m) is a power consumption of a bus per transfer of a data byte (although it can also represent said consumption per clock cycle) at a certain operation mode, PPC_F_ind(m) is a power consumption per cycle at a certain operation mode of a modeled hardware component that its power consumption does not depend upon the clock signal frequency, and PPC_Leak is the leakage power consumption of a typical modeled hardware component per clock cycle.

When the integrated circuit includes more than a single frequency domain the inventors took into account losses resulting from power regulation required to provide different voltages to different frequency domains, these losses are represented by a factor denoted SO. Accordingly, an alternative set of equations was used:

PPC(m)=Iinit(m)*V*(V+SO)/(Vinit(m)*Finit(m)). (5)

PPC_bus=BusCoeff*C*V*(V+SO). (6)

PPC_{—}F_{—}ind(m)=Iinit(m)*V*(V+SO)/(Vinit(m)*F). (7)

PPC_Leak=LeakCoeff*Iinit(S)*(V+SO)/F. (8)

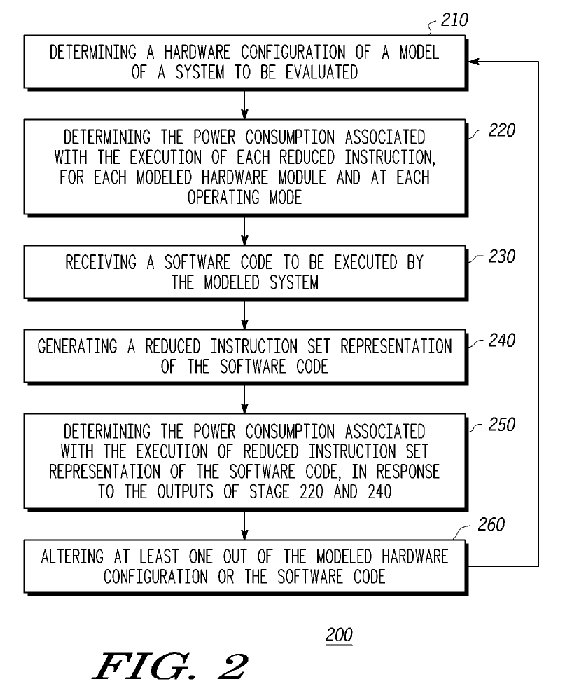

FIG. 2 is a flow chart of method 200 for determining a power consumption of a system that executes a software code, according to an embodiment of the invention.

Method 200 starts by stage 210 of determining a hardware configuration of a model of a system to be evaluated. Stage 210 includes determining the parameters of each modeled hardware component (such as timing parameters, arbitration scheme, and the like) of the modeled system, including the power consumption parameters of each modeled hardware component at each operating mode. Stage 210 also includes determining the connectivity between the modeled hardware modules, priorities and the like. Referring to the example set forth in FIG. 1, stage 210 includes determining how modeled hardware components 11-17, 21-23, 31-33, 41, 51-52, 61-61 and 71-73 are connected to each other, which signals can be exchanged between each of these modeled hardware components, and the like. In addition, each modeled hardware components parameters are set. This stage may also include defining frequency domains. For example each modeled processor can belong to a different frequency domain.

Stage 210 is followed by stage 220 of determining the power consumption associated with the execution of each reduced instruction, for each modeled hardware module and at each operating mode. The determination can involve estimations, calculations, simulations, measurements and the like. Referring to the example set forth in FIG. 1, the power consumption of each modeled hardware component, at each operation mode can be determined. The time required for executing a reduced instruction is also determined (usually in terms of clock cycles), thus the power consumption per instruction is determined.

Stage 220 is followed by stage 230 of receiving a software code to be executed by the modeled system.

Stage 230 is followed by stage 240 of generating a reduced instruction set representation of the software code.

Stage 240 is followed by stage 250 of determining the power consumption associated with the execution of reduced instruction set representation of the software code, in response to the outputs of stage 220 and 240. Referring to the example set forth in FIG. 1, the power consumption of system 100 is determined by determining how the various modeled hardware components of system 100 operate in order to complete the execution of the reduced instruction set representation of the software code.

Stage 250 may be followed by stage 260 of altering at least one out of the modeled hardware configuration or the software code and jumping to stage 210. Said repetition of stage 210-250 may continue until a predefined control criterion (such as amount of iterations, reaching a target power consumption level, and the like) is fulfilled.

It is further noted that multiple different software codes can be evaluated before altering the hardware configuration, but this is not necessarily so.

FIG. 3 is a flow chart of method 300 for determining a power consumption of a system that executes a software code, according to an embodiment of the invention.

Method 300 starts by stage 310 of determining the modeled hardware configuration of a system to be evaluated. Stage 310 includes determining the parameters of each modeled hardware component (such as timing parameters, arbitration scheme, and the like), including the power consumption parameters of each modeled hardware component at each operating mode. Stage 310 also includes determining the connectivity between the modeled hardware modules, priorities and the like.

Stage 310 is followed by stage 320 of receiving a software code to be executed by the modeled system.

Stage 320 is followed by stage 330 of generating a reduced instruction set representation of the software code.

Stage 330 is followed by stage 340 of simulating the execution reduced instruction set representation of the software code to determine, for each modeled hardware component, the operating modes in which it operated and the amount of time it operated at each operating mode.

Stage 340 is followed by stage 350 of determining the power consumption of the modeled system in response to the outcome of stage 340 and the power consumption parameters of at least some of the modeled components of the modeled system. These modeled components may include the modeled components that were involved in the execution of the software code, but this is not necessarily so. Conveniently, stages 340 and stage 350 are executed in parallel, but this is not necessarily so.

Stage 350 may be followed by stage 360 of altering at least one out of the modeled hardware configuration or the software code and repeating stages 310-350. Said repetition may continue until a predefined control criterion (such as amount of iterations, reaching a target power consumption level, and the like) is fulfilled.

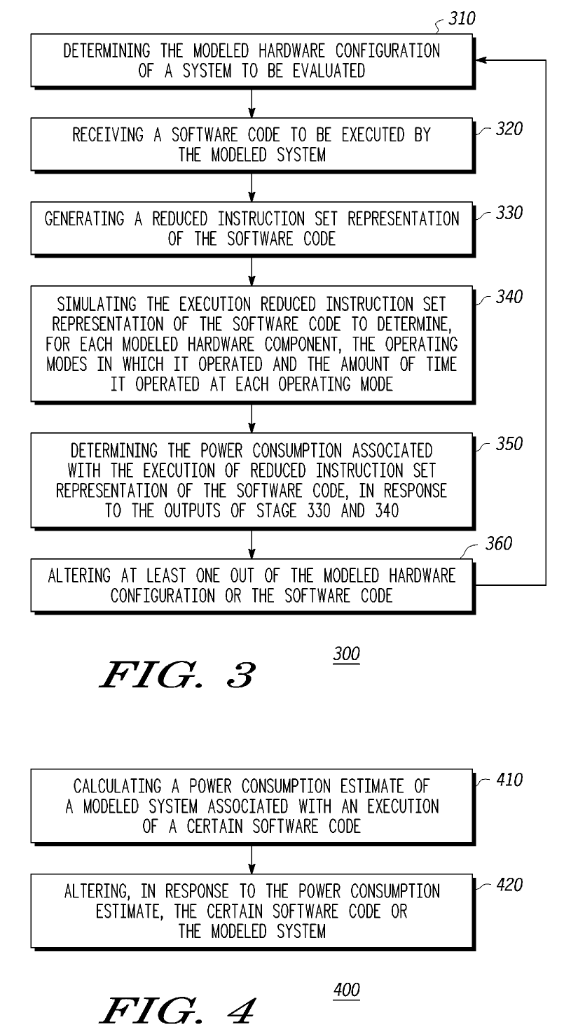

FIG. 4 is a flow chart of method 400 of for determining system and software configuration, according to an embodiment of the invention.

Method 400 starts by stage 410 of calculating a power consumption estimate of a modeled system associated with an execution of a certain software code. Stage 410 can include, for example stages 210-250 or stages 310-350, but this is not necessarily so.

Stage 410 is followed by stage 420 of altering, in response to the power consumption estimate, the certain software code or the modeled system.

TABLE 2 illustrates some exemplary code portions for defining power consumption parameters of various components, according to an embodiment of the invention.

| Code | | Explanation |
|---|---|---|
| $panama_ptms {‘ptm1’} = | | Setting global parameters |
| | F=300 | such as characteristic |

| | |
|---|---|
| ‘power_table’ = { | voltage, current and |

| | |
|---|---|
| Vinit=2.3, | frequency for different |
| Finit=30000000, | operation modes such as |
| Iinit= {‘active’ = 100.1, | active, idle and stop. |

| | |
|---|---|
| ‘idle’ | = 10, |

| | |
|---|---|
| ‘stop’ | = 0,}}} |

| $panama_buses{‘bus1’} | | Setting a certain bus |
|---|---|---|
| | F= 300, | (bus1) related parameters |
| | ‘power_table’ = { | such as characteristic |

| | |
|---|---|
| Vinit=2.3, | voltage, as well as |

| | Data_bus_C = 2, | capacitance of data bus |
|---|---|---|
| | Address_bus_C = 3,} | and address bus. |
| $global_power_parameters= { | | Setting global power |
| | ‘volt_to_leak_coeff’ = [ | consumption parameters |

| | |
|---|---|
| [2.3, 1], [1.2, 1]], | such as leakage |

| | |
|---|---|
| switch offset = 0.5, | coefficients, bus |

| | bus_coefficient= 0.2,}, | | coefficients (defaults). |
|---|---|---|---|
| $panama_domains{domain1}= { | | | Defining a domain |
| | V | = 2.3, | (domain1) and its |

| | |
|---|---|
| Time_to_idle = 1 ns, | parameters including time |
| ‘modules’= {M1, BA} | to report entrance to |

idle mode and voltage.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method for determining system and software configuration, the method comprises:
calculating a power consumption estimate of a modeled system associated with an execution of a certain software code;
altering, in response to the power consumption estimate, the certain software code or the modeled system;
whereas at least one modeled hardware component of the modeled system is configured to operate at different operating modes associated with different power consumption levels.

2. The method of claim 1 whereas the stage of calculating comprises providing a reduced instruction set representation of the software code.

3. The method of claim 2 comprising generating the reduced instruction set in response to a trace representation of the software code.

4. The method of claim 2 wherein the reduced instruction set comprises multiple power setting instructions.

5. The method of claim 2 further comprising determining a power consumption of the modeled system when executing at least one reduced instruction.

6. The method of claim 5 wherein the determining comprises determining power consumption of at least one modeled hardware component of the modeled system.

7. The method of claim 5 further comprising determining an operating mode of at least one modeled hardware component.

8. The method of claim 1 further comprising evaluating multiple different software codes before altering the modeled system.

9. The method of claim 2 whereas the reduced instruction set comprises data retrieval instruction.

10. The method of claim 2 whereas the reduced instruction set comprises a modeled processor execution instruction.

11. The method of claim 1 whereas the stage of calculating comprises determining an operating mode of at least one modeled hardware component of the modeled system.

12. The method of claim 1 whereas the stage of calculating comprises determining, for multiple modeled hardware components of the modeled system, an operating mode of operation and an amount of time the modeled hardware components operated in said at least one operation mode, during an execution of the software code.

13. A method of determining a power consumption of a system that executes a software code, the method comprises:
calculating a power consumption estimate of a modeled system associated with an execution of a reduced instruction set representation of a software code;
providing a reduced instruction set representation of the software code;
wherein the reduced instruction set comprises read, write and execute instructions.

14. The method of claim 12 comprising generating the reduced instruction set in response to a trace representation of the software code.

15. The method of claim 12 wherein the reduced instruction set comprises multiple power setting instructions.

16. The method of claim 12 further comprising determining a power consumption of the modeled system when executing at least one reduced instruction.

17. The method of claim 15 wherein the determining the power consumption of the modeled system comprises determining power consumption of at least one modeled hardware component of the modeled system.

18. The method of claim 15 further comprising determining an operating mode of at least one modeled hardware component.

19. The method of claim 15 whereas at least one modeled hardware component is configured to operate at different operating modes associated with different power consumption levels.

20. The method of claim 12 whereas the reduced instruction set comprises data retrieval instruction.

21. The method of claim 12 whereas the reduced instruction set comprises a modeled processor execution instruction.

22. The method of claim 12 whereas the stage of calculating comprises determining, for multiple modeled hardware components of the modeled system, an operating mode of operation and an amount of time the modeled hardware components operated in said at least one operation mode, during an execution of the software code.
